(19) United States
(12) Patent Application Publication
(10) Pub. No.: US 2020/0025169 A1
(43) Pub. Date: Jan. 23, 2020

(54) Vertical-axis wind rotor

(71) Applicant: KLIUX ENERGIES INTERNATIONAL, INC., Chicago, IL (US)

(72) Inventors: Juan Jose EGUIZABAL GARCIA, Chicago, IL (US); Jose Luis CEREZO LOTINA, Logrono, La Rioja (ES)

(21) Appl. No.: 16/040,768

(22) Filed: Jul. 20, 2018

(51) Int. Cl. F03D 3/06; F03D 3/00

(52) U.S. Cl. CPC F03D 3/061; F03D 3/064; F03D 3/065; F03D 3/007; F05B 2250/71; F05B 2240/301; F05B 2260/901; F05B 2250/25; F05B 2240/212

(57) ABSTRACT

A vertical-axis wind rotor configured by concave-convex type airfoil profiles in the form of vertical helical protrusions, tilted towards counter-rotation and twisted around, the chord decreasing, where both ends are finished in the form of sharklets rotated towards the upper surface so as to eliminate the vortex, and distributed in a circular pattern around the rotation shaft thereof. The angular arrangement of the chord of the section of the profile with a spoke with respect to the shaft of the rotor is particular for making the profile work under lift conditions before reaching the normal under drag forces and complementing them, eliminating jerking, with the direction of rotation being indicated by the Coriolis effect and determining the radial distribution, the radius, the chord, the profile, and the number of them, which confers to the rotor the maximum terminal velocity at which it slows down, being maintained by the Magnus effect.

### FIELD OF THE INVENTION

The present invention relates to a vertical-axis wind rotor for configuring wind turbines, intended for converting the kinetic energy of a fluid, i.e., the wind, into rotational energy so that it can be utilized. It employs a configuration of aerodynamic profiles, i.e., airfoil blades or vanes, arranged in a circular pattern about a shaft, offering a low starting torque and, in turn, low revolutions, as well as self-regulated turns.

The invention is comprised among machines intended for utilizing moving fluid resources, and more specifically machines intended for renewable energies.

### BACKGROUND OF THE INVENTION

Vertical-axis turbines are known to provide modest or intermediate amounts of energy. In contrast, they are in high demand for self-consumption installations, whether for residential use or in small facilities.

A number of vertical-axis wind rotors that utilize drag or lift forces are known, such as the Savonius and Darrieus models, for example. Horizontal-axis wind-driven power generators are also known, and these power generators primarily use lift force when the leading edge of the airfoil profile is arranged facing the direction of the wind, similar to airplane propellers.

Vertical-axis wind turbine rotors experience low performance, given that half of the vanes are arranged directly facing the fluid to generate rotation and the other half are arranged facing the fluid under counter-rotation. As an advantage, they do not require orientation with respect to the dominant flow of the fluid and are easy to build.

Savonius models and the like primarily use drag forces, also defined as thrust forces, having surfaces that are primarily concave in the direction of the wind (“scoop” effect), and offering limited performance, given that half of the surface is arranged directly facing the fluid to generate rotation and the other half is arranged facing the fluid under counter-rotation (the profile is thrust), which detracts from rotation in the first condition. Thrust also occurs in short bursts, which leads to what are referred to as jerking, which causes fatigue in the system and lowers the performance.

Darrieus models and the like primarily use lift forces, with the leading edges of the airfoil section arranged facing the direction of the wind (flight effect).

As regard to the efficiency, acquired speed, and smoothness, lifting (lift) is preferred and the most modern machines primarily use this principle in the operation thereof.

One of the drawbacks of using airfoil profiles is the induced drag generated at their ends, where both the lift (lifting) thrust and the drag thrust, which are antagonistic to one another, are combined abruptly at their ends, (FIG. 7), generating a passive resistance, i.e., a vortex, which resists movement.

Horizontal-axis wind rotors are also known, but they have a number of problems and drawbacks such as the need of a mechanical brake for regulating turns or the need to stop the rotors if winds are strong, turbulent, or gusty, etc.

Furthermore, horizontal-axis rotors are subjected to extensive vibration during operation, cause noise pollution, and are dangerous for birds.

No rotors which self-regulate their own rotation due to their configuration are known in any case.

Furthermore, none of the known wind contrivances completely utilize upward currents produced on hills, by the outer walls of buildings, cliffs, etc., where these currents are produced at the same time as others, such as gusty winds, or winds from any direction.

### BRIEF DESCRIPTION OF THE INVENTION

The invention relates to a vertical-axis wind rotor having new features that are novel and involve inventive step, whereby the problems and drawbacks raised above are resolved in a satisfactory manner, in addition to offering new benefits and improvements that will be explained throughout the present description.

A first object of the invention is to provide a different vertical-axis wind rotor, which provides maximum performance and is permanently oriented towards the wind without the need for additional structures or conventional brakes. This rotor allows using a low wind speed for starting up.

A second object of the invention is to achieve a rotor with maximum utilization of any type of wind, whatever the direction and force thereof, in addition to not requiring orientation. It uses gusty winds, whirlwinds, directional winds, or upward winds. It is ultimately truly efficient for omnidirectional winds.

A third object of the invention consists of obtaining a rotor which self-regulates its own rotating speed which prevents rotor revolutions from racing with high speeds of the dominant fluids, with self-regulation being initiated by the slowing down or stalling of the system.

A fourth object of the invention is to achieve a rotor which eliminates the “jerking” during rotation as the fluid goes from one profile to the next in a progressive and smooth manner.

A fifth objective is to increase the surface arranged facing the wind applied in particular embodiments; the objective of eliminating vortices from the airfoil tips and elongating the effective airfoil surface is furthermore achieved without increasing span. The induced drag of the vortices generated at the tips of the airfoil profiles is utilized by adding devices with the shape of a sharklet in a similar way to the method used in aviation with devices referred to as “winglets”.

A sixth objective is to reduce the surface of the rotor arranged facing counter-rotation, and for that purpose the lift and drag effects produced in the vanes of the rotor are combined and added together.

The device of the invention is configured from aerodynamic airfoil profiles developed particularly for this purpose, or also from standard airfoil profiles, which shall be referred to hereinafter as vanes, but which run in a particular manner along their circumferential position, projection, and arrangement around a shaft.

Given the applied technology, the arrangement, the inventiveness applied and the design, the invention offers a huge step forward with respect to the current state of the art, particularly due to the concepts applied, in the technical field of the renewable energies.

Furthermore, the invention discloses a high-performance and maintenance-free device.

In a preferred embodiment, the airfoil profiles are attached to the shaft only by means of spokes, in a way that the need to arrange discs or plates at the ends of the airfoils is eliminated, making the use with gusty or upward winds easier, in addition to allowing the placement of optional winglets.

The present invention is the result of the study and development of a vertical-axis wind rotor made up of airfoil profiles configured in a particular manner, which use and complement drag forces, lift forces, and the forces of gusty and upward currents to which any aerodynamic airfoil profile is subjected when arranged facing a fluid, in an optimal manner and at any angle, around the 360° of the section thereof.

According to the invention, a master asymmetrical airfoil, preferably having a concave configuration in the lower surface and a convex configuration in the upper surface and an optimized section, is used as a basis, such that when arranged facing the flow of a fluid, it creates an enormous lift force and also extensive drag.

The stall line or terminal velocity of a preferred airfoil profile must be consistent with the speed of the flow of the predominant fluid existing at the installation site. The selection of the terminal velocity and therefore the degree of concavity and convexity of the airfoil profile is made in function of the maximum terminal angular velocity the rotor is desired to reach with respect to the speed of the predominant fluid.

The rotor can be made with any other known profile, such as those profiles that are already classified, i.e., NACA, RAF, GOE, Clark, GAW, Goettingen, Eppler, Wortmann, Liebeck, and other airfoils, from a range of different technical fields, i.e., the aeronautical field, the wind field, or other fields, obtaining worse but reasonably similar results.

The vertical-axis wind rotor has a series of vanes or airfoil profiles with a concave lower surface and a convex upper surface, and each airfoil profile having an upper end and a lower end. The vanes are connected to a rotational energy extraction rotating shaft.

The chord of the airfoil profiles decreases in an upward direction along the airfoil profile. This gives the fluid circulating in the concave part (lower surface) a “scoop” effect, causing the fluid compression and a Venturi effect, which tends to kick said fluid out faster and reduce the parasitic drag thereof.

The distance from the airfoil profile to the shaft of the rotor increases in the upward direction along the airfoil profile. The final edge having a smaller chord but at a greater distance from the center of the shaft of the rotor makes up for the moment of thrust of the initial edge, having a larger chord and smaller radius. The moment of thrust of the different sections are therefore compensated for.

The airfoil profiles have an angle of twist which increases in the upward direction along the airfoil profile. In other words, the angle of torsion of the profile increases upon moving upward. The torsioning (twisting) of the profile increases the offset angle of the chord of the profile with respect to its spokes. Being advanced under counter-rotation means that the first thrust due to lift first and the subsequent thrust due to drag occur at the same time in different sections of the profile.

The airfoil profiles are arranged in the form of a helical pattern with the upper part tilted towards counter-rotation. This helicoidal configuration of the arrangement of the vanes means that greater contact with the fluid prevails, and it eliminates the jerking or the impacting of the fluid as the action of the fluid goes from a vane to the empty space between vanes and to the other vane, where said jerking effect is very damaging for the system.

The helicoidal configuration also helps the thrust due to lift to transition into thrust due to drag in a smoother, more progressive, and more continuous manner, since both situations occur in the same airfoil profile, even in different sections of the same profile at the same time, favoring the continuity and smoothness of the movement, minimizing the forces needed to start up the rotor.

Preferably, at least one of the upper or lower tips is finished with a sharklet oriented towards the upper surface thereof. These sharklets will have a certain vertical component, and they will resemble elements known as winglets, blended winglets, a wingtip fence, wing let, etc.

These sharklets eliminate or reduce the induced or parasitic drag caused by airfoil tip vortices (FIG. 7), and improve the aerodynamic performance of the airfoil profiles, increasing the specific airfoil surface area, with a limited increase in material in the airfoil span.

Having defined the airfoil profiles and their arrangement, the chord of the airfoil profile is angularly positioned with respect to the spoke to the center of the shaft of the rotor, such that the leading edge is arranged facing the fluid ahead of the rotation, which causes thrust to the rotor due to the lift effect to occur sooner, detracting it from that of counter-rotation, which would be caused under other conditions. Therefore, the increased rotor performance is defined by the thrust that is detracted from the counter-rotation, which occurs because the profile is subjected to lift before thrust in the counter-rotation area, so each profile comes into contact with the fluid in the counter-rotation area, in the minimum lift angle of attack thereof to transition to the maximum lift angle of attack thereof, such that rotation reduces that angle of attack until taking it back to the minimum lift angle of attack, at which time the lower surface captures the fluid, where it now operates under thrust, no longer working under lift to then continue with the rotation in its favor, until being lost in rotation thereof with the fluid. This causes only a small section of the rotor to be subjected to thrust under counter-rotation. As is conventional, the angle of attack will be defined as that angle produced between the chord and the direction of the fluid.

Similarly this occurs with the fluid that has entered the rotor and wishes to exit behind the rotor, the same thing occurs, but with the trailing edge of the profile as if it were the leading edge, instead of with the attack from the front, causing another increase in system performance.

The degree of increase in rotor performance is defined as a function of the selected angle between the chord of the profile with the spoke of the airfoil profile to the center of the rotor, and the selected angle of the leading edge of the vane with respect to the direction of the flow of the fluid at the start of the interaction. This allows the lift performance to occur sooner, as if it were an airplane wing, before acting due to wind drag, this portion or angle of lead allows increasing the active working surface under rotation, due to lift thrust, and detracting it from the surface when thrusting under counter-rotation.

The angle of the chord with respect to the spoke is configured so that contact with the fluid, after the “shadow” of the preceding airfoil profile disappears, takes place in the minimum angle of lift, transitioning to maximum lift and minimum lift before acting like a thrust vane. The concave part acts like a scoop collecting the wind, until in rotation it makes the airfoil profile lose contact with the fluid.

The number of vanes arranged around the perimeter of the rotor, the value of the chord, the radius, and the arrangement thereof, establish the angular separation between vanes. All this determines the maximum rotating speed of the system. If this speed is exceeded, the vanes themselves will cast a shadow and the speed will simulate the rotor as if it were a solid of revolution, thereby producing the Magnus effect. The fluid does not enter the rotor, and it is only the Magnus effect (the speed of the fluid and the rotation of the rotor) that generates a moment that keeps it moving and prevents it from slowing down. If it slows down for any reason, the shadow will be lost and it will speed back up due to thrust on the vanes. This therefore determines an automatic aerodynamic brake, which is what is calculated prior to installation and replaces the conventional mechanical or electrical brake normally used, rotation being maintained by the mentioned Magnus effect. In order for the Magnus effect to occur, the rotor acts like a rotating solid, and the fluid does not enter same, but rather goes around it. Said effect, i.e., acting like a solid, occurs after given rpm, according to the configuration. If the rotor slows down, the Magnus effect disappears and normal thrust occurs. It thereby works like a maximum revolution regulator.

This final condition is configurable for different rotor revolutions, as a function of external conditions and, most importantly, the number of radially distributed elements, the smaller the number of elements the higher the configured terminal velocity and vice versa, for the same other conditions.

The direction of rotation of the rotor is not random or whimsical as it may seem to be, but rather is configured according to the hemisphere in which the rotor is located and the direction of rotation of the currents defined by the Coriolis effect and the latitude at which it is located, which help improve performance.

### BRIEF DESCRIPTION OF THE DRAWINGS

To complement the description that is being made and for the purpose of helping to better understand the features of the invention, a set of drawings is attached as an integral part of said description in which the following has been depicted with an illustrative and non-limiting character:

FIG. 1 shows an example of a preferred aerodynamic airfoil profile.

FIG. 2 shows an aerodynamic profile arranged facing a fluid, along its entire contour.

FIG. 3 shows a lift thrust graph of the preferred profile along its 360°.

FIG. 4 shows a drag thrust graph of the preferred profile along its 360°.

FIG. 5 shows a graph of the sum of the lift and drag thrusts of the preferred profile.

FIG. 6 shows the protrusion of a preferred airfoil.

FIG. 7 shows an explanation of the creation of vortices of an airfoil profile when arranged facing a fluid.

FIG. 8 shows a protrusion of an airfoil profile with dissipative tips, i.e., sharklets.

FIG. 9 shows a preferred arrangement of the protrusion as a basis for the circular pattern around a rotating shaft.

FIG. 10 shows views of an example of the complete rotor, with nine repetitions of the preferred airfoil profile.

FIG. 11 shows an advanced arrangement of the chord of the profile with respect to the spoke of the rotor

FIG. 12 shows a graph of the work in one section of the rotor with normal profile arrangement.

FIG. 13 shows a graph of the work with the arrangement of the chord being advanced and the profile tilted.

FIG. 14 shows an explanatory view of the Magnus effect.

FIG. 15 shows an infinitesimal section of the rotor explaining the working shapes of the vanes.

Said drawings show the following various parts or components:
1 Airfoil profile
2 Chord [of the aerodynamic profile]
3 Lower surface
4 Upper surface
5 Leading edge
6 Trailing edge
7 Angle of twist
8 [Rotating] shaft [of the rotor]
9 Lower spoke
10 Upper spoke
11 Positioning angle of the lower section (with respect to the advancement of the chord)
12 Positioning angle of the upper section (with respect to the advancement of the chord)
13 Chord of the lower section
14 Chord of the upper section
15 Upper sharklet
16 Lower sharklet
17 Lateral component of the Magnus effect
18 Moment (generated by the Magnus effect to continue the rotation)
19 Lift starting area
20 Lift area
21 (Lift losing and) and drag starting area
22 Drag area

### DETAILED DESCRIPTION OF THE INVENTION

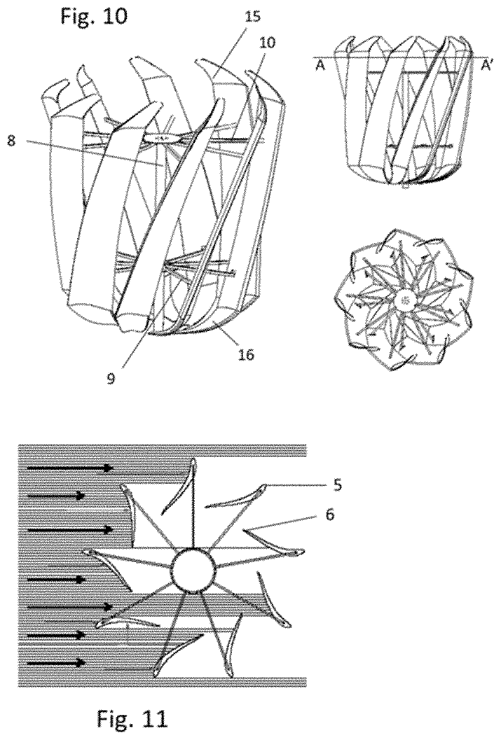

In view of the described drawings, it can be seen how the proposed rotor (FIG. 10) is preferably constituted from a shaft (8) surrounded by respective airfoil profiles (1), with nine of such profiles (1) having been depicted arranged in a circular pattern and equidistant from one another.

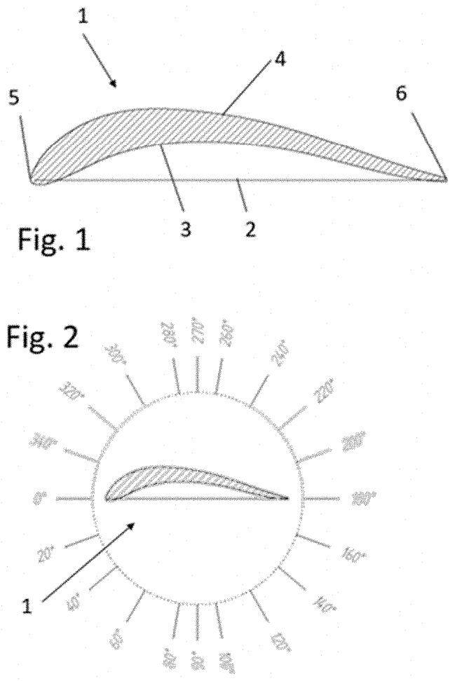

The airfoil profile (1) is preferably an asymmetrical airfoil with a convex configuration on the upper surface (4) and concave configuration on the lower surface (3) and an optimized section, as shown in FIG. 1. Its aerodynamic characteristics are shown in the enclosed table. These airfoil profiles (1) create an enormous lift force as well as enormous thrust on the lower surface (3), being the desired ideal configuration.

| | |
|---|---|
| Thickness | 10.6% |
| Camber | 13.2% |
| Trailing edge angle | 8° |
| Lower flatness | 25% |
| Leading edge radius | 4.5% |
| Max CL | 2.5 |
| Max CL angle | 12° |
| Max CD | 11.2 |
| Max CD angle | 104° |

Characterization of the airfoil profile or vane selected as preferred:

The selected vanes or airfoil profiles (1) must work simultaneously under lift and drag, with both actions complementing one another but one being predominant over the other according to the position occupied in the circle of fluids (FIG. 2), i.e., from where the fluid attacks or makes contact, and the angle formed by the direction of the flow of the fluid with the chord (2) of the airfoil profile (1).

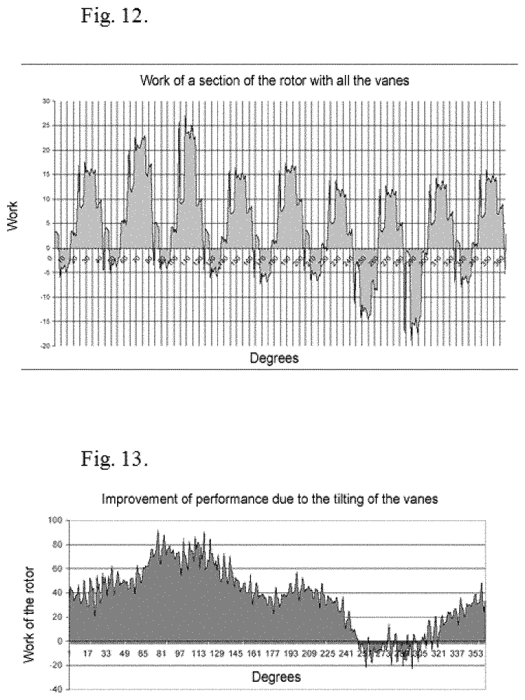

These airfoil profiles (1) are “tilted” with an angle of twist (7) the value of which is arrived at by subtracting the positioning angle of the upper section (12) and subtracting the positioning angle of the lower section (11), in the vertical protrusion thereof (FIG. 10), in a helical manner. In other words, the angle between the chord of each horizontal section and the corresponding rotation radius is increasing in the upward direction, between a value greater than 90° and a value less than 180° (FIG. 12). The upper end therefore is not located above the lower end, but rather is shifted against the direction of rotation of the rotor, so a longer vane-fluid contact time and a smooth transition from a lift action to a thrust action are achieved in the airfoil profile itself. These helical characteristics of the vanes eliminate the differences in thrust as the action of the fluid of a vane passes to the empty space between two vanes and then on to another vane. This eliminates the so-called “jerking” (FIG. 12) in order to achieve a more regular and continuous operation without jerking (FIG. 13), as well as a smoother start, which furthermore requires less power to start the movement. This improvement increases with the number of vanes, such that the more vanes there are, the greater the improvement.

Furthermore, unlike known wind contrivances, the currents coming up from hills, as well as the other currents that have been explained, such as gusty currents, or currents from any direction, are utilized in their entirety, all of which is made possible by the difference between the angle of twist (7), achieving a rotor for truly omnidirectional winds.

These airfoil profiles (1) also have chords (13, 14) that are smaller as the height at which they are located increases. The lower chord (13) will be longer than the upper chord (14). A scoop effect in part of the lower surface (3) is thereby created, causing a Venturi effect, i.e., the fluid is compressed and accelerated in it, kicking it out faster and reducing parasitic drag.

Slight vertical thrust is also caused, which invites the system to levitate due to the aforementioned effect plus the helical tilting of the airfoil profiles (1) when arranged facing the fluid, given that as a result the flow becomes detached and breaks down into a horizontal component and another vertical component which is what invites the system to levitate.

This levitation of the rotor during its rotation could be used for various applications, such as reducing weight or making start-up and rotation easier. It can also be used for arranging differential mechanical brakes in the proximity thereof or for arranging proportional dynamic generators in the proximity thereof and other applications.

As indicated, the chord (2, 13, 14) of the airfoil profile (1) is smaller as the height at which it is located increases. Furthermore, twisting is greater and the rotation radius is increased, moving away from the shaft (8) as the height at which it is located increases. The upper spoke (10) for fixing the airfoil profile (1) to the shaft therefore has a greater length than the lower spoke (9), and the latter is rotated with respect to the former in the direction of rotation. However, the basic characteristics of the profile are maintained, so the angle which the section advances in the protrusion of the section does not correspond with the advance of the angle of attack, rather this is affected by a counter-rotation of the chord itself due to the twisting.

These characteristics obtain a partial reorientation of the profile with respect to the attack of the fluid, as the profile rotates, so the profile receives the thrust of the fluid for more time, and the minimum wind requirements for the start up thereof are reduced.

However, in order to self-regulate rotor rotation, the fact that the upper surface (4) acts like a lift element and stalls if the terminal velocity of the section is exceeded in connection with its lift coefficient is taken advantage of. This stalling automatically brakes the system. It is an automatic aerodynamic brake for the natural stabilization of the speed of the rotor itself that does not require any intervention.

In order to work under the greatest possible lift, for the purpose of increasing the rotor turning revolutions and maintaining the rotational inertia, efforts should be made to maximize the surface area of the upper surface (4), i.e., configure a master profile for reaching a terminal velocity of the section and from there stalling and braking it.

The final shape and configuration of each airfoil profile (1) is that which results in each case from integrating the foregoing. The torsional moment generated in each infinitesimal section must be constant so as to prevent generating internal fatigue and stress in the mentioned airfoil profiles (1), and the entire airfoil profile (1) can therefore work under identical conditions. As a result, and in the vertical projection thereof, the leading edge (5) is progressively displaced with respect to the profile, the upper edge of the airfoil profile (1) being located a greater distance from the center of the shaft (8) than the lower edge thereof. The upper chord (14) has a rotation radius that is greater than the lower chord (13). With all this, the rotor is circumscribed in an inverted frustoconical volume having a curved generatrix. The resultant forces are therefore compensated by separating the center of mass of each section, rendering the torsional moments identical and continuous. The conical shape limits fluid compression capabilities, thereby making it easier for the fluid to exit rotor.

The airfoil profiles (1) are distributed uniformly according to a circular pattern around their rotating shaft (8), with each of the preceding configurations and with their angles of attack (5) oriented outwards and their upper surfaces oriented inwards from the rotor. The chord (2, 13, 14) is twisted during rotation with respect to the spoke from the shaft (8) of the rotor to the leading edge (5) by a portion that is equal to the difference of the angles of attack (11, 12).

The angles of attack (11, 12) are extremely important, together with the minimum lift angle of the airfoil profile (1), since they provide additional work that is performed by lift. These are responsible for the airfoil profile (1) to start its work before reaching the normal to the shaft (8) of the rotor by a leading angle with respect to the normal direction of the fluid. The performance thereof thereby increases by the amount of advance of the angle of attack (11, 12) because it generates movement sooner under lift and because it does not brake the counter-rotation of the rotor in the same portion in this advance, which is an authentic novelty. As can be seen in FIG. 15, when the airfoil profile comes into contact with the fluid, it is oriented for receiving it on its upper surface (4) under minimum lift, entering a lift starting area (19). Upon continuing with rotation, it goes to a maximum lift area (20). A little further ahead it enters a drag starting area (21), where it loses lift and gains thrust, to then continue with the thrust when it receives fluids on the lower surface (3) until reaching the drag area (22).

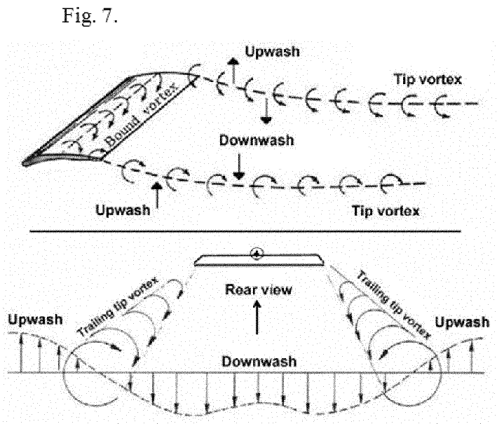

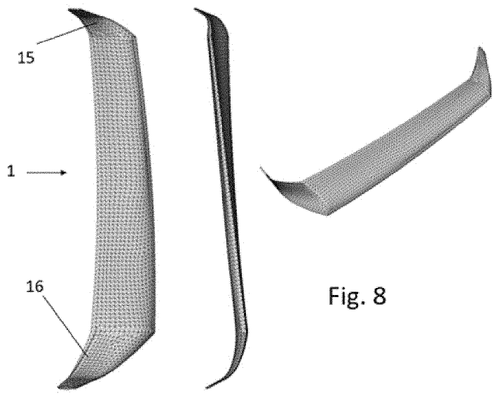

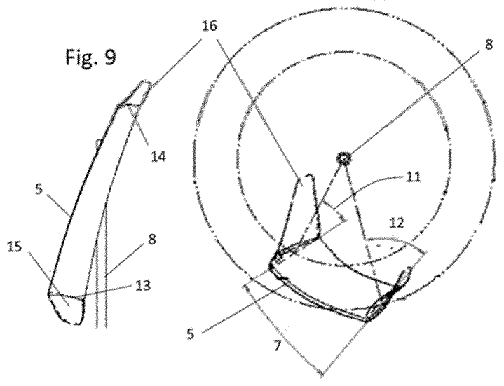

In addition, it includes another novelty in the development of the airfoil profile (1) as the ends are finished with respective sharklets (15, 16) oriented towards the upper surface and with a small vertical component (the upper sharklet (16) is oriented slightly upwards, whereas the lower sharklet (15) is oriented somewhat downwards). It thereby utilizes the induced drag of the vortices generated at the ends of the airfoil profiles (FIG. 7), and in turn causes a physical and theoretical increase in the airfoil surface.

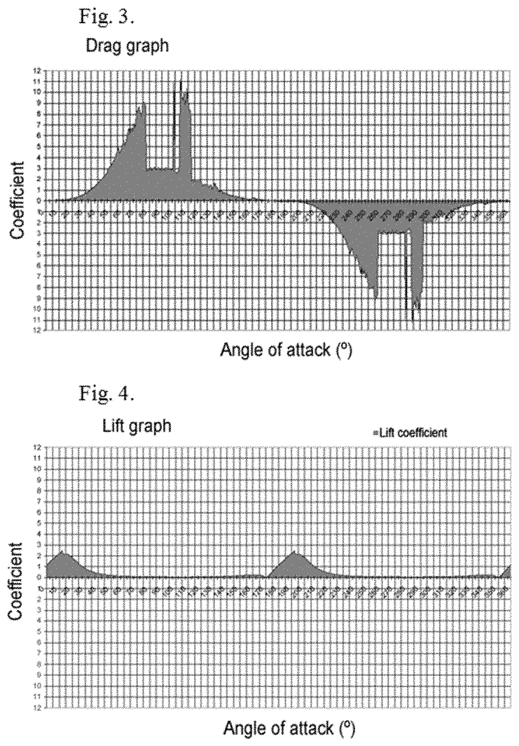

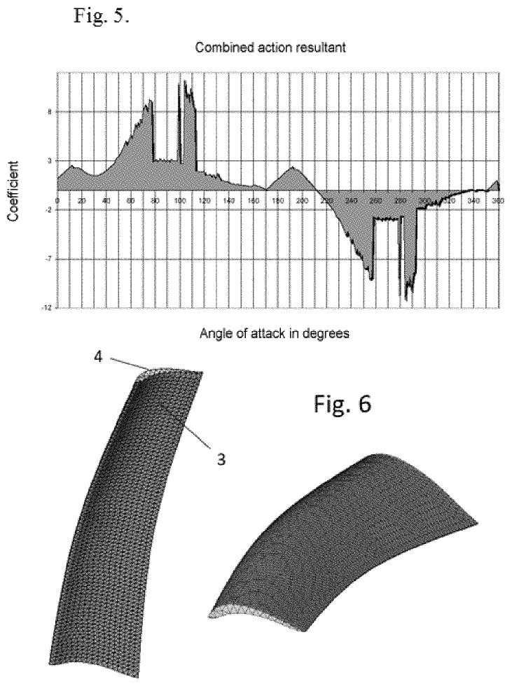

FIG. 3 shows a behavior analysis of the preferred airfoil profile (1) under the action of a fluid directed towards it in any direction surrounding its 360°. The graphs of FIGS. 4 and 5 with the lift and drag coefficients are obtained. The work generating capacity of the mentioned airfoil profile (1) in each of the positions it occupies with respect to the direction of the dominant fluid is derived from this result.

The graphs of the variation of the lift coefficient (FIG. 4) and drag coefficient (FIG. 3), as well as variation of the specific characteristics of the preceding table have been obtained by means of simulation. The graphs refer to both the amount and the relative position of the direction of the fluid under the action of the airfoil profile, this being referenced with respect to its chord (2).

Once the corresponding lift and drag graphs have been obtained and integrated in a behavior graph (FIG. 5), the infinitesimal work of the mentioned profile is obtained.

It is enough to simply select the arrangement of the angles of attack (11, 12) that each section of the profile of the vane occupies in the distribution on the plane orthogonal to the shaft (8), the surface area, the number of vanes, the speed of the fluid, the density thereof, and the distances to the shaft (8) in order to finally obtain the power developed at all times in the mentioned rotor in an infinitesimal manner

(FIG. 12), in the case of vertical protrusion. The empty spaces or jerking and the negative works under counter-rotation can be seen in said drawing.

However, when the helical protrusion of the profiles is arranged such that the ends thereof are offset in a rotational manner and also vertically with an angle of twist (7) towards counter-rotation direction of the rotor (FIG. 10), and integrating this in the infinitesimal work of FIG. 12, the improvement in work and performance, the elimination of empty spaces, and the reduction of negative works are thereby achieved, with the computation thereof being depicted in the graph of FIG. 13.

The airfoil profiles (1) also utilize the turbulent winds produced by the other vanes. Once the fluid has entered the center of the rotor and has to exit, it again produces work as the fluid is exiting, and aerodynamic lift and thrust of the assembly are maintained. The trailing edge (6) of the airfoil profile (1) drives the flow of the fluid inside the rotor under counter-rotation thereof so that it can be picked up by the trailing edge (6) of the opposite airfoil profile (1), and it again generates movement favoring the rotation thereof.

This offset configuration under counter-rotation of the airfoil profile (1) with respect to the shaft (8) also allows picking up the upward currents and making them favor the rotor during its rotation and increase the levitation effect of the rotor.

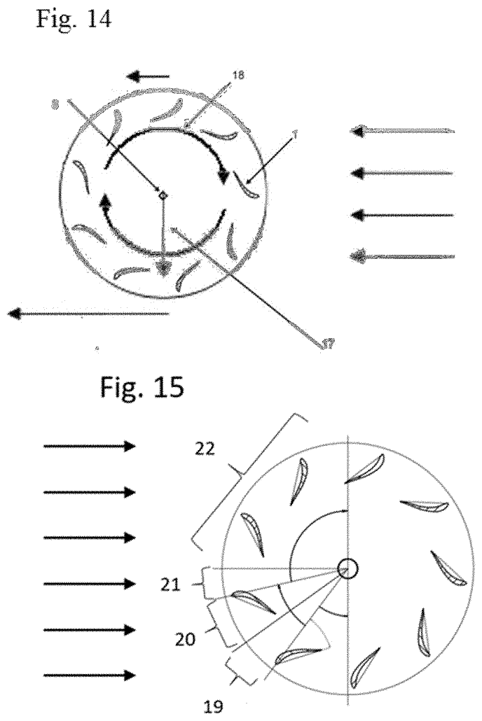

The self-regulation of the rotating speed of the rotor depends per se on dominant wind speed, in which the profile will stall. For the design the instant of stall is determined, configuring the selected aerodynamic profile (1) as a function thereof, which results in not having to brake it under extreme conditions since it acts like a solid. Under that condition, it is kept in motion due to the Magnus effect, which generates an impulse (FIG. 14), preventing deceleration, the differential component generates a moment (18) due to the Magnus effect to continue rotating, with the lateral component of the Magnus effect (17) of said impulse being absorbed by the rotor supporting structure.

The direction of rotation of the rotor will be selected by the Coriolis effect and depends on the hemisphere of application.

The result is that provided that this rotor is oriented facing the wind, said rotor is omnidirectional and does not have to be braked even under extreme circumstances.

The system offers wind turbine-related advantages consisting of better performance than those offered today in the conditions of light wind, gusty wind, and turbulent wind, as well as winds produced during storms and hurricanes, resulting in a system for omnidirectional winds.

All this is physically performed with maximum simplicity in a compact, simple, cost-effective, and maintenance-free manner.

1. Vertical-axis wind rotor, configured with a series of airfoil profiles with a concave lower surface and a convex upper surface, defining a chord between the ends of each lower surface, connected to a rotational energy extraction rotating shaft, each airfoil profile having an upper end and a lower end, and wherein:
the chord of the lower surface of the airfoil profiles decreases in the upward direction along the airfoil profile;
the distance from the airfoil profile to the shaft increases in the upward direction along the airfoil profile;
the airfoil profiles have a positioning angle of the section which increases in the upward direction along the airfoil profile,
the airfoil profiles are arranged in the form of a helicoidal pattern with the upper part tilted towards counter-rotation; and
the airfoil profiles are arranged with the leading edges outwardly from the rotor and with the upper surface arranged inwardly therefrom.

2. Vertical-axis wind rotor according to claim 1, wherein at least one of the upper and lower tips is finished with a sharklet oriented towards its upper surface.

3. Vertical-axis wind rotor according to claim 1, the airfoil profiles of which are attached to the shaft by one or more spokes.

4. Vertical-axis wind rotor according to claim 1, the airfoil profiles of which, when arranged facing a fluid, have the chord thereof arranged at an angle with respect to the spoke thereof attaching it to the shaft of the rotor being advanced so that, due to thrust, the profile comes into lift before coming into thrust.

5. Vertical-axis wind rotor according to claim 1, the configuration of which is frustoconical with a curvilinear generatrix.

6. Vertical-axis wind rotor according to claim 1, in that the maximum terminal velocity at which it slows down and stops is maintained by the thrust of the Magnus effect that is produced.
